(19) United States
(12) Patent Application Publication
(10) Pub. No.: US 2025/0371989 A1
(43) Pub. Date: Dec. 4, 2025

(54) Wearable Educational Garment with Integrated Audio Learning System

(71) Applicant: Robert Cage, Rochester, NY (US)

(72) Inventor: Robert Cage, Rochester, NY (US)

(21) Appl. No.: 19/219,258

(22) Filed: May 27, 2025

Related U.S. Application Data
(60) Provisional application No. 63/655,022, filed on Jun. 2, 2024.

(51) Int. Cl. G09B 5/04; A41D 1/00; H04R 1/02

(52) U.S. Cl. CPC G09B 5/04; A41D 1/002; H04R 1/025; H04R 1/028; A41D 2400/00; H04R 2201/023

(57) ABSTRACT

The present invention relates to a wearable garment that integrates a user-activated audio module into a custom-designed housing unit affixed to the fabric. The audio module emits pre-programmed sound content such as songs or instructional audio to support early learning. The module is removable, rechargeable, and may be updated with new content. Activation is accomplished through a button accessible from the outside of the garment. The invention is particularly useful for promoting independent learning in young children, including those with developmental challenges, and operates independently of screens or external devices.

### CROSS-REFERENCE TO RELATED APPLICATIONS

This application claims the benefit of U.S. Provisional Patent Application No. 63/655,022, filed on Jun. 2, 2024, which is incorporated herein by reference in its entirety.

### FIELD OF THE INVENTION

The present invention relates to wearable educational technology, specifically garments with embedded audio playback systems for early learning.

### BACKGROUND OF THE INVENTION

Wearable technology has made significant advances in health, fitness, and communication, yet there is a lack of wearable technology designed to support early childhood development through interactive learning. Most educational tools—such as flashcards, books, or mobile apps—require direct supervision or concentrated attention, which may not suit the developmental needs or natural behavior of young children. The present invention addresses this need by integrating a functional audio system directly into a child's everyday garment. This innovation allows children to independently activate educational content throughout the day, encouraging organic repetition, and reinforcing learning in a playful, familiar environment. Unlike other audio-based toys or learning devices, the invention is worn on the body, ensuring the sound source is always accessible without interrupting play or requiring external devices.

This combination of wearable comfort and interactive audio functionality introduces a novel approach to early learning-one that aligns with the lifestyle and developmental needs of young children.

The invention may also be beneficial for children with developmental challenges, offering consistent sensory feedback and promoting structured engagement.

Currently, no known garments integrate a fully enclosed, removable audio system in a child-safe wearable form that promotes independent educational interaction.

### SUMMARY OF THE INVENTION

The present invention is a wearable garment that integrates a user-activated audio system to engage the wearer through sound. Designed primarily for children, the garment features a custom holder permanently affixed to the fabric. This holder securely retains a removable audio module that emits pre-programmed content such as educational songs, musical tones, or instructional audio.

The audio module can be easily inserted or removed, allowing for recharging, updates, or cleaning of the garment without damaging the electronics. Activation occurs via a user-accessible button on the exterior of the audio module, encouraging repeated use and reinforcing learning through auditory interaction and independent play.

The holder may be made of PVC or any comparable flexible and durable material, integrated in a way that maintains the garment's comfort, safety, and visual appeal for daily wear.

This invention uniquely combines apparel and interactive technology to create a hands-on, wearable learning experience that supports early educational development through frequent, on-demand engagement.

The system operates independently, requiring no external screens or connected devices, making it ideal for unsupervised, screen-free learning.

### BRIEF DESCRIPTION OF THE DRAWINGS

FIG. 1 is a front view of a wearable garment, such as a T-shirt, illustrating the housing unit affixed to the exterior surface of the garment.

FIG. 2 is a front view of the garment shown in FIG. 1, illustrating the audio module as it is resting inside the housing unit.

FIG. 3 is a perspective view of the audio module configured to emit sound upon activation.

FIG. 4 is a perspective view of the housing unit, designed to receive and retain the audio module.

FIG. 5 is an exploded perspective view showing the alignment and insertion of the audio module into the housing unit.

FIG. 6 is an exploded view showing the modular nature of the system, detailing the garment, housing unit, and audio module as separate but integrable components.

### DETAILED DESCRIPTION OF THE INVENTION

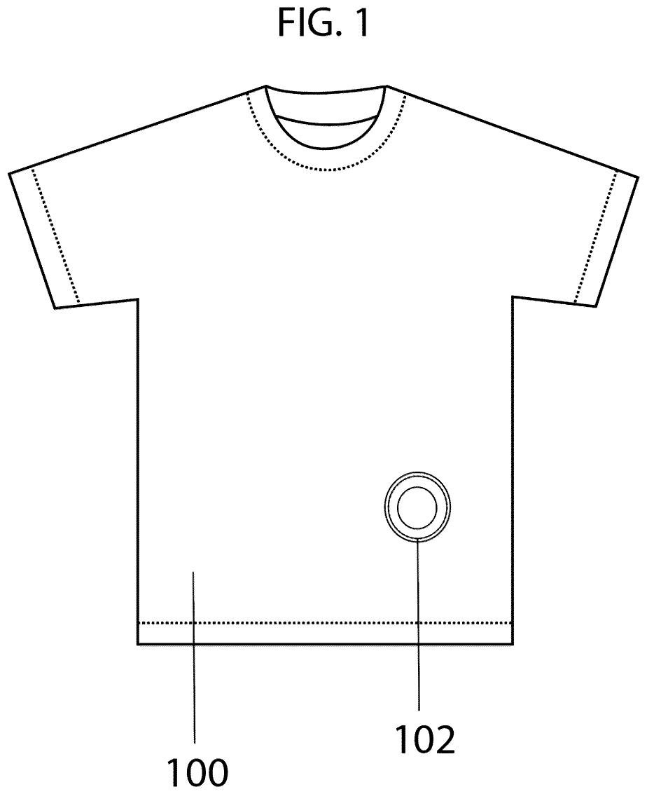

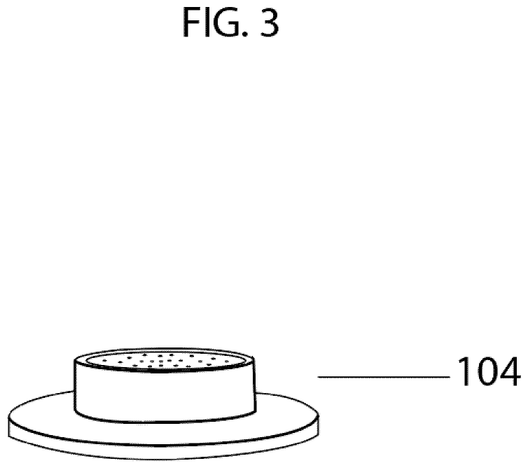

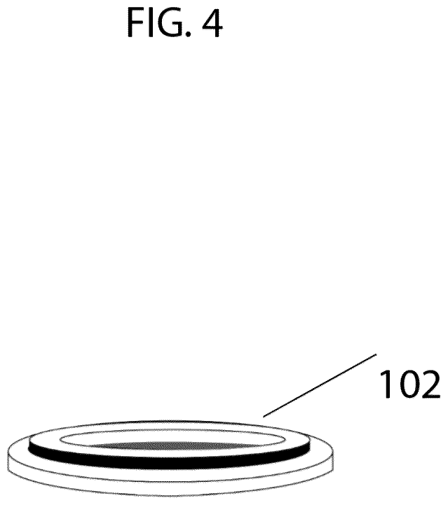

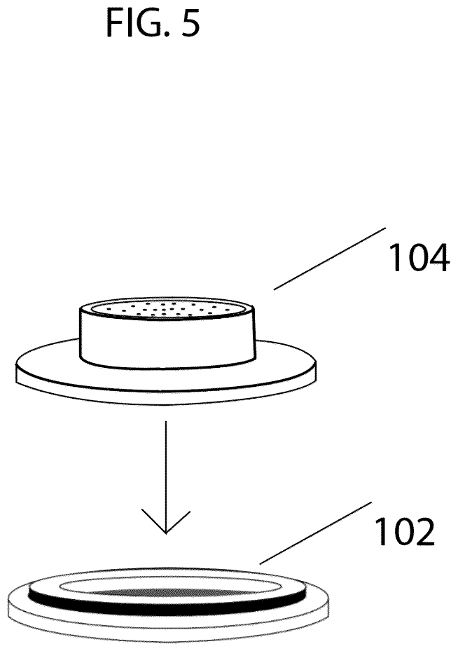

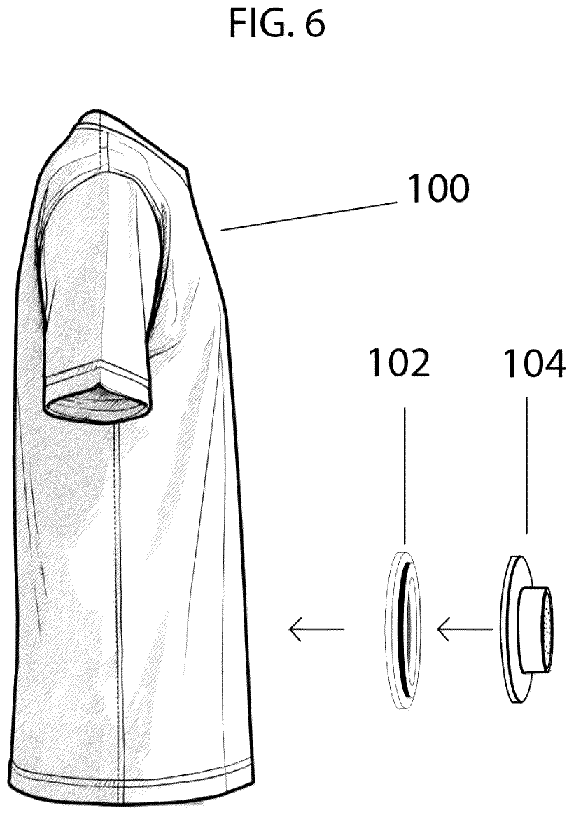

The following detailed description refers to FIGS. 1 through 6, which illustrate various views and embodiments of the present invention.

In the drawings, a wearable garment is shown, with a T-shirt depicted as the preferred embodiment, designated generally as 100. However, it should be understood that the garment may take the form of any clothing article worn on or over the torso, including but not limited to long-sleeve shirts, sweatshirts, onesies, or jackets.

The invention integrates an interactive audio engagement system into the garment, consisting primarily of a housing unit 102 and a removable audio module 104. The novelty of the invention lies in the structured relationship and integration between these components and the garment itself.

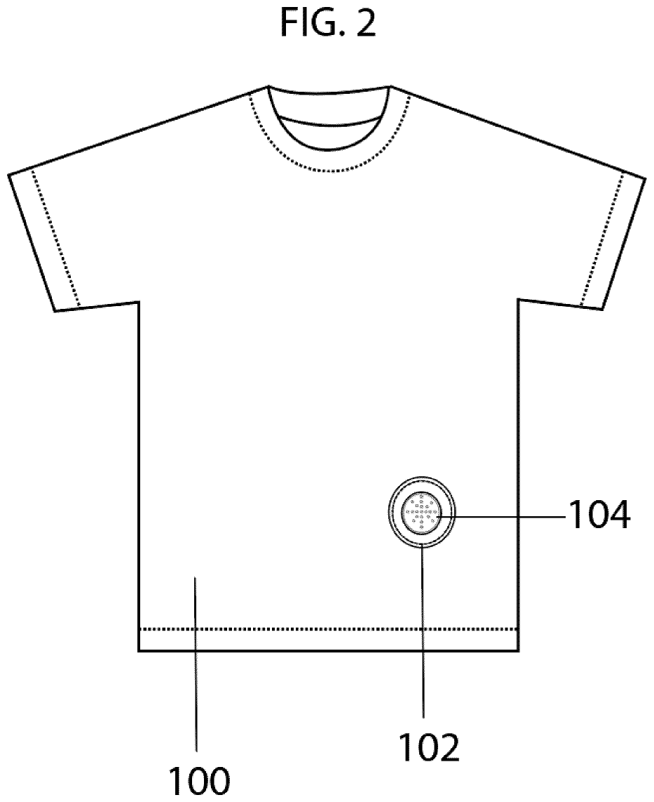

As shown in FIG. 2, the housing unit 102 is permanently affixed to the garment 100 using stitching, adhesive, heat bonding, hook-and-loop fasteners (e.g., Velcro), or similar attachment methods. The housing unit 102 is positioned directly on top of the garment fabric and is designed to securely hold the audio module 104, providing a snug fit that prevents movement or dislodgement during typical use.

The housing unit 102 acts as a protective enclosure or receptacle that bridges the audio device and the garment. It may be manufactured from PVC, silicone, rubber, or other durable materials suitable for contact with children and resistant to light cleaning or gentle washing, and compliant with CPSIA (Consumer Product Safety Improvement Act) guidelines for children's products, including limits on small parts and chemical exposure. Importantly, this unit allows for the audio module 104 to be inserted or removed by an adult, facilitating recharging, replacement, or content updates.

The audio module 104 is a pre-programmed, battery-powered module capable of emitting sound upon user activation. The audio module 104 includes an embedded speaker, oriented outward within the housing to ensure clear sound projection during wear. The housing unit 102 includes a central opening that allows the user to directly access and press the button on the audio module 104, which sits securely within the housing unit 102. The sound output may include, but is not limited to, songs, educational phrases, or engaging tones designed to support early learning.

In some embodiments, the audio module further includes wireless connectivity such as Bluetooth, Wi-Fi, or NFC. This enables remote updates to the stored audio content, tracking of user engagement data (e.g., button presses or listening duration), or syncing with companion mobile applications for parental monitoring, progress reporting, or content customization.

In the preferred embodiment, the housing unit 102 is positioned on the front of the garment. However, other placements-such as the sleeve, shoulder, upper chest, or lower front panel—are within the scope of the invention.

This configuration transforms an ordinary garment into an interactive learning tool that is safe, comfortable, and visually appealing, while promoting repeated engagement and independent learning in young children.

In additional embodiments, the invention is adapted for use by children with developmental delays or sensory processing challenges, including autism spectrum disorders. The device's repetitive, audio-based stimuli may offer therapeutic benefit, promote engagement, and support structured learning routines through consistent, on-demand playback of auditory cues.

1. A wearable learning garment comprising:
a wearable garment;
a housing unit permanently affixed to the garment;
an audio module configured to be removably secured within the housing unit,
wherein the audio module emits sound comprising music, speech, or educational content.

2. The wearable learning garment of claim 1, wherein the audio module is configured to receive additional content via USB or Bluetooth connection.

3. The wearable learning garment of claim 1, wherein the garment is a t-shirt, sweatshirt, or similar upper-body clothing.

4. The wearable learning garment of claim 1, wherein the housing unit is constructed of a flexible, washable material.

5. The wearable learning garment of claim 1, wherein the audio module is powered by replaceable batteries.

6. The wearable learning garment of claim 1, wherein the audio module is powered by an internal rechargeable battery and charged via a USB port.

7. The wearable learning garment of claim 1, wherein the audio module is pre-programmed with a set of audio content upon manufacture.

8. The wearable learning garment of claim 2, wherein the audio module includes non-volatile storage for downloading, removing, and replacing audio content.

9. The wearable learning garment of claim 1, wherein the audio module is housed within a waterproof enclosure.

10. The wearable learning garment of claim 1, wherein the housing unit includes an opening that allows direct access to a user-activated button on the audio module.

11. The wearable learning garment of claim 1, wherein the housing unit is positioned on the chest, sleeve, shoulder, or lower panel of the garment.

12. The wearable learning garment of claim 2, wherein the downloaded audio content includes interactive educational programs targeted toward early childhood development.

13. The wearable learning garment of claim 1, wherein the audio module is removable, allowing replacement or upgrading with a compatible module offering enhanced features.

14. The wearable learning garment of claim 1, wherein the audio output includes tones, melodies, or spoken educational phrases configured to reinforce memory through repetition.

15. A method of reinforcing early childhood education using a wearable learning garment, comprising the steps of:
providing a wearable garment with an affixed housing unit;
inserting a functioning audio module into the housing unit;
activating the audio module to emit pre-programmed educational content;
enabling a child wearer to independently trigger the content via a user-activated button;
repeating the exposure to said content through daily wear of the garment,
thereby reinforcing memory and promoting autonomous learning, and enhancing cognitive retention in early developmental stages.

16. The method of claim 15, wherein the educational content is downloaded from an online platform and stored on the audio module.

17. The method of claim 15, wherein the repeated engagement with the audio module occurs during routine play or movement.

18. The method of claim 15, wherein the educational content includes phonics, counting, or other early literacy and numeracy material.

19. The wearable learning garment of claim 1, wherein the audio module includes wireless connectivity configured to enable content updates, user data tracking, or communication with an external application.

20. A wearable interactive educational system comprising:
a garment configured for wear on the upper body;
a housing unit affixed to an outer surface of the garment;
an audio module removably retained within the housing unit;
a user-activated control on the audio module;
a speaker embedded in the module configured to emit sound,
wherein the system enables repeated, on-demand playback of educational audio content during ordinary garment wear.

21. The wearable learning garment of claim 1, wherein the housing unit is designed to prevent accidental removal of the audio module and includes safety features such as recessed buttons, tamper-resistant seams, rounded edges, and dimensions that exceed the size of a child's windpipe to prevent accidental swallowing, thereby complying with consumer product safety standards for children's products.

22. The wearable learning garment of claim 1, wherein the audio module is dimensioned to be larger than a child's windpipe, thereby reducing the risk of accidental ingestion in compliance with safety regulations. Thereby complying with consumer product safety standards for children's products.
